(19) United States
(12) Patent Application Publication
(10) Pub. No.: US 2004/0012893 A1
(43) Pub. Date: Jan. 22, 2004

(54) Aerodynamic actuator assembly

(76) Inventor: Srinivas Tadepalli, Eden Prairie, MN (US)

Correspondence Address: Derek J. Berger, Seagate Technology LLC, Intellectual Property - COL2LGL, 389 Disc Drive, Longmont, CO, 80503, US

(21) Appl. No.: 10/442,849

(22) Filed: May 21, 2003

Related U.S. Application Data
(60) Provisional application No. 60/396,450, filed on Jul. 17, 2002.

(51) Int. Cl. G11B 5/55

(52) U.S. Cl. 360/266

(57) ABSTRACT

An actuator assembly including at least one actuator arm to position a head for read/write operations. The actuator assembly includes a tapered or profiled transition zone proximate to the cantilevered end of the actuator arm to provide a tapered flow transition between the actuator arm and a suspension assembly coupled to the actuator arm and having the head coupled thereto. In one embodiment, the tapered or profiled transition zone includes converging surfaces to provide the tapered flow transition between the actuator arm and suspension assemblies coupled thereto.

### CROSS-REFERENCE TO RELATED APPLICATION

This application claims priority from U.S. Provisional Application No. 60/396,450 filed on Jul. 17, 2002 entitled “AERODYNAMIC PROFILING OF THE E-BLOCK TIP TO REDUCE SUSPENSION AIR FLOW EXCITATION.”

### FIELD OF THE INVENTION

The present invention relates generally to data storage devices, and more particularly but not by limitation to actuator assembly for a data storage device having a profiled transition zone to control flow induced excitation.

### BACKGROUND OF THE INVENTION

Some data storage devices store digitally encoded information on discs. Heads may be used to read data from or write data to these discs, which may be supported for rotation by a spindle motor or drive. The heads may be coupled to an actuator assembly to position the heads relative to selected data tracks in order to read and/or write data from the discs. A flexible suspension assembly may be used to couple the heads to the actuator assembly. The flexible suspension assembly typically includes a gimbal spring to allow the head to pitch and roll relative to the disc surface.

Rotation of the disc creates an air flow along the disc surface for read/write operations. Constriction of air flow along the disc surface or geometry changes along the air flow path creates a turbulent air flow pattern, which increases as spindle rotation speed increases. Turbulent air flow proximate to the suspension assembly (and in particular a pre-load bend region of the suspension assembly or suspension arm) may increase excitation of the suspension vibration modes which can interfere with track following. What the prior art has been lacking is a way to diminish the effects of turbulent airflow upon actuator suspensions and heads.

### SUMMARY OF THE INVENTION

The present invention relates to an actuator assembly. The actuator assembly includes a tapered or profiled transition zone to provide a tapered flow transition between the actuator arm and a suspension assembly coupled to the actuator arm. In one embodiment, the tapered or profiled transition zone includes converging surfaces to provide the tapered flow transition between the actuator arm and suspension assemblies coupled thereto. Other features and benefits that characterize embodiments of the present invention will be apparent upon reading the following detailed description and review of the associated drawings.

### BRIEF DESCRIPTION OF THE DRAWINGS

FIG. 1 is a perspective illustration of an embodiment of a data storage device.

FIG. 2 is an exploded plan view of an actuator assembly to position heads for read/write operation.

FIG. 3 is an elevational view and FIG. 4 is a perspective view schematically illustrating a transition zone between an actuator arm and suspension assemblies coupled thereto.

FIG. 5A is an elevational view schematically illustrating an embodiment of a linearly tapered or profiled transition zone between an actuator arm and a suspension assembly.

FIG. 5B is an elevational view schematically illustrating an embodiment of a tapered stepped transition zone between an actuator arm and a suspension assembly.

FIG. 6 is an elevational view and FIG. 7 is a perspective view schematically illustrating an embodiment of a tapered or profiled transition zone between an actuator arm and opposed suspension assemblies.

FIGS. 8-9 are elevational views schematically illustrating different embodiments for converging surfaces for a tapered or profiled transition zone.

FIG. 10 is a perspective illustration of an embodiment of an actuator arm including tapered or profiled edges along a mounting portion of the actuator arm to provide a tapered or profiled transition zone between the actuator arm and suspension assembly or assemblies mounted thereto.

FIG. 11 is a cross-sectional view taken along line 11-11 of FIG. 10.

FIG. 12 is a cross-sectional view taken along line 12-12 of FIG. 10.

### DETAILED DESCRIPTION OF ILLUSTRATED EMBODIMENTS

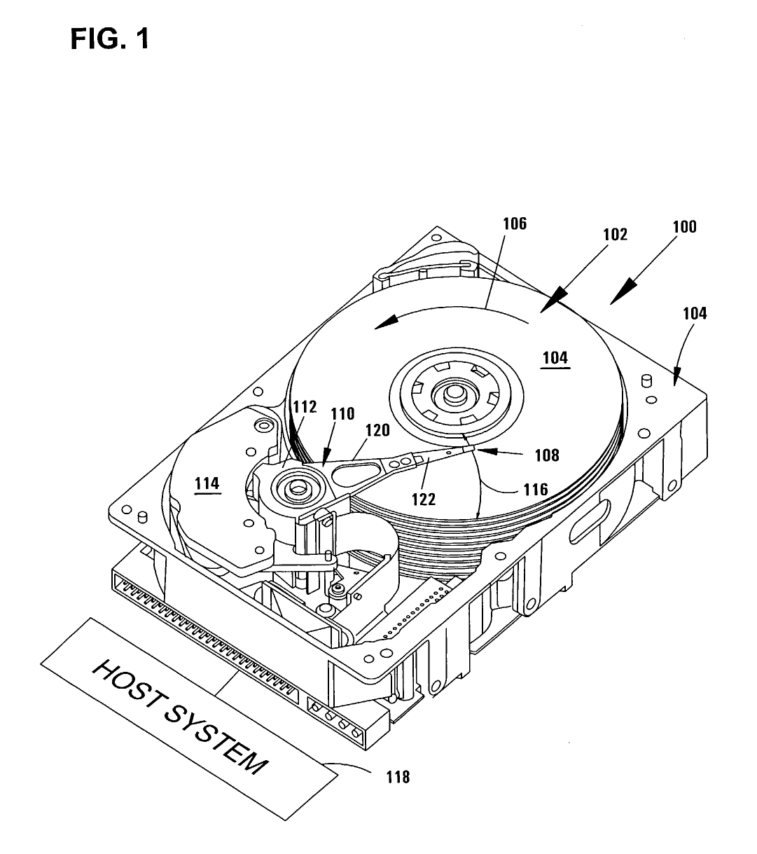

FIG. 1 is a perspective illustration of a data storage device 100 in which embodiments of the present invention are useful. In the embodiment shown, the data storage device 100 includes a plurality of discs 102 rotationally supported relative to a base chassis 104 as illustrated by arrow 106. Heads 108 (such as for example, magnetoresistive, magneto-optical or inductive heads) are coupled to an actuator assembly 110 to position the heads 108 to read data from or write data to the discs 102. In the embodiment shown, the actuator assembly 110 includes an actuator block 112 which is rotationally or movably coupled to the base chassis 104. The actuator block 112 is rotated via operation of a voice coil motor (VCM) 114 to move the heads 108 as illustrated by arrow 116 relative to selected tracks on the disc 102 based upon commands or signals from a host system 118 (illustrated schematically).

In the embodiment illustrated in FIG. 1, the actuator block 112 includes a plurality of actuator arms 120 (only one visible in FIG. 1) to support a plurality of heads relative to the plurality of discs 102 of a disc stack. Heads 108 are coupled to flexible suspension assemblies 122 (only one visible in FIG. 1) which are coupled to and extend from the plurality of actuator arms 120 of the actuator block 112. Although FIG. 1 illustrates a device including a plurality of actuator arms 120, application of the present invention is not limited to a device including a plurality of actuator arms as shown.

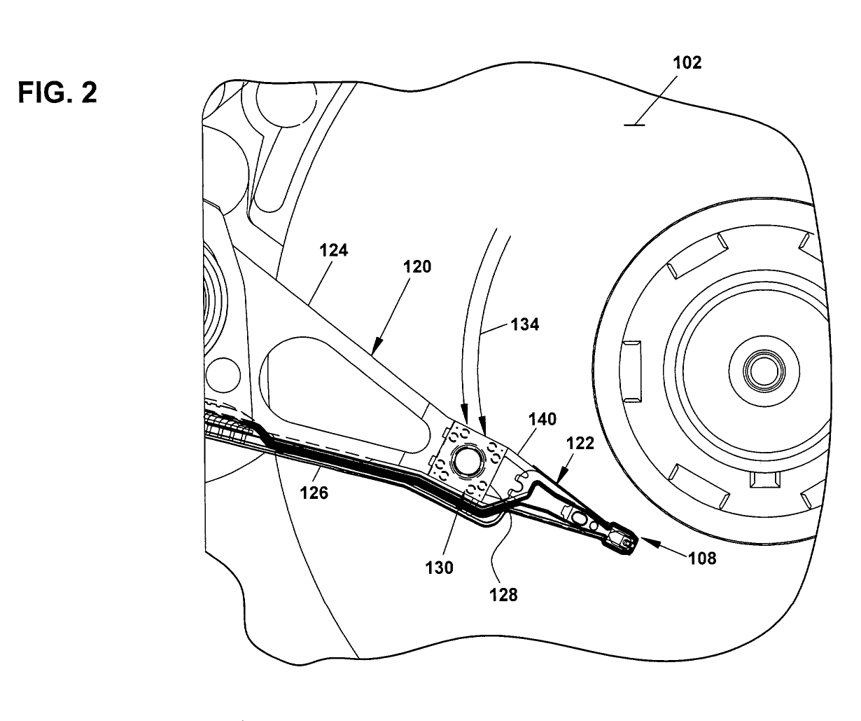

As illustrated in the embodiment shown in FIG. 2, the actuator arm 120 has an elongated cantilevered length defined by opposed first and second side edges 124,126 and a cantilevered edge 128 at a cantilevered end of the actuator arm 120. The suspension assembly 122 extends from the cantilevered end of the actuator arm 120 to support the head 108 for read/write operations. In the embodiment, shown, the suspension assembly 122 is coupled to or swaged to a mounting portion 130 of the actuator arm 120 defined by an area between the opposed first and second side edges 124,126 and the cantilevered edge 128 proximate to the cantilevered end of the actuator arm 120.

As shown in FIG. 2, rotation of disc 102 creates an air flow along the disc surface which is constricted along the actuator assembly, as illustrated by arrow 134. For proximity or near proximity recording, the head may include an air bearing slider carrying transducer elements (such as magneto-resistive, magneto-optical or inductive transducer elements) for read/write operations. Air flows from a leading edge to a trailing edge of the air bearing slider to provide a lifting force for read/write operations. The suspension assembly 122 includes an elongated suspension arm or load beam which may have a flexible pre-load bend region 140 to provide a pre-load force to the head 108. The lifting force and pre-load force define in part a fly height of the head or slider for proximity or near proximity recording.

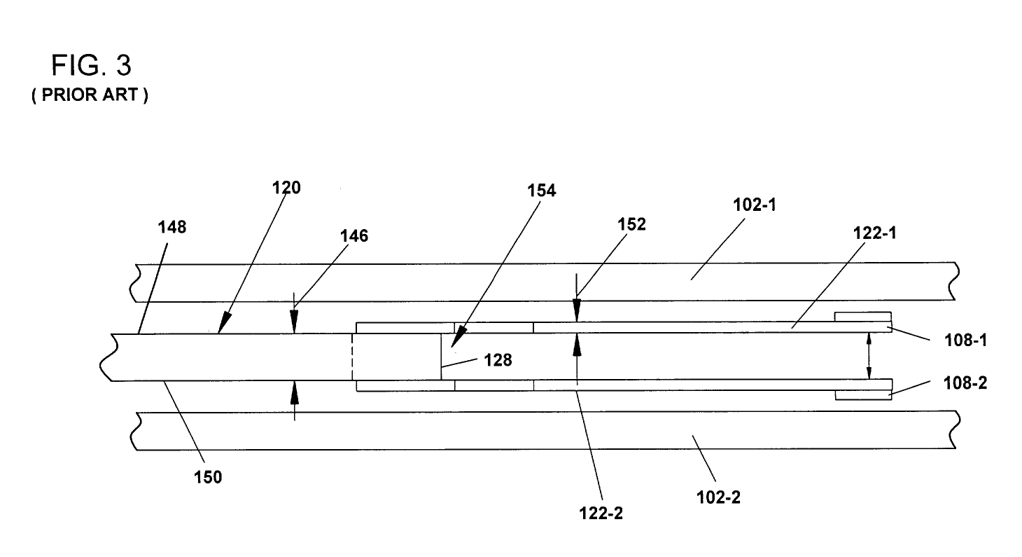

In the embodiment illustrated in FIG. 3, opposed suspension assemblies 122-1,122-2 are coupled to the actuator arm 120 and extend between discs 102-1,102-2 of a disc stack for read/write operations. As shown, the actuator arm 120 includes a thickness 146 between opposed surfaces 148,150 of the actuator arm 120. The suspension assemblies 122-1,122-2 coupled to the actuator arm 120 have a smaller thickness 152 than the thickness 146 of the actuator arm. As illustrated in FIGS. 34, dimensions 146,152 of the actuator arm 120 and suspension assemblies 122-1,122-2 introduce a thickness step or flow transition zone 154 between the actuator arm 120 and the suspension assemblies 122-1,122-2. An abrupt transition of air flow or geometry at the transition zone creates a turbulent flow pattern which can excite vibration. Turbulent flow proximate to the pre-load bend region 140 of the suspension assembly can excite resonance modes of the suspension and gimbal assemblies.

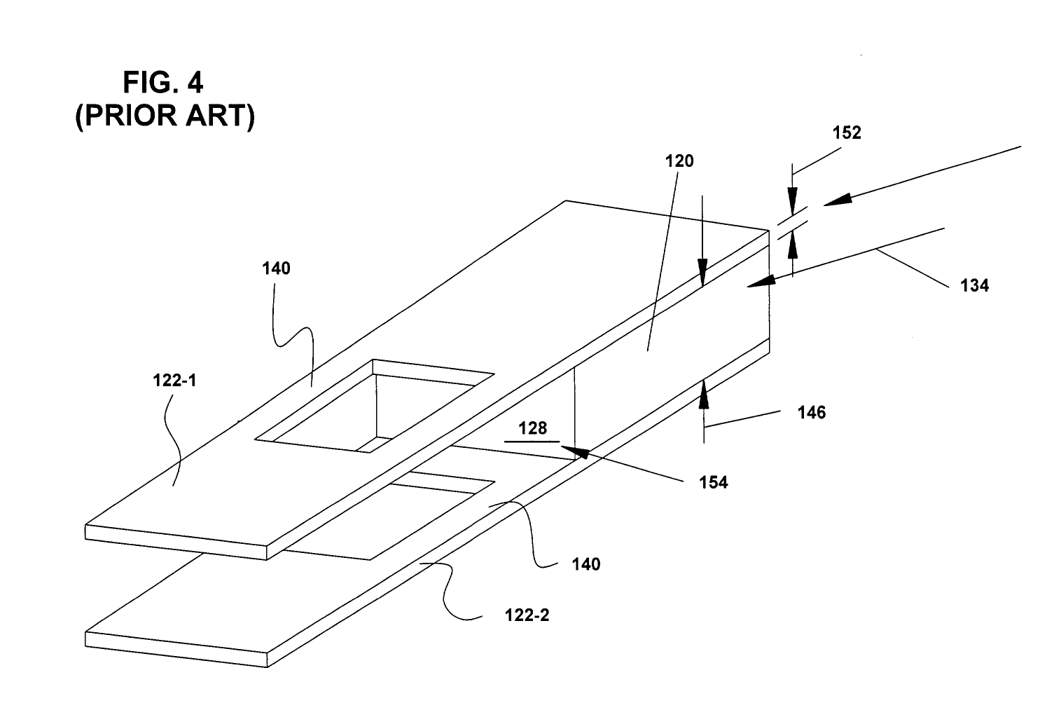

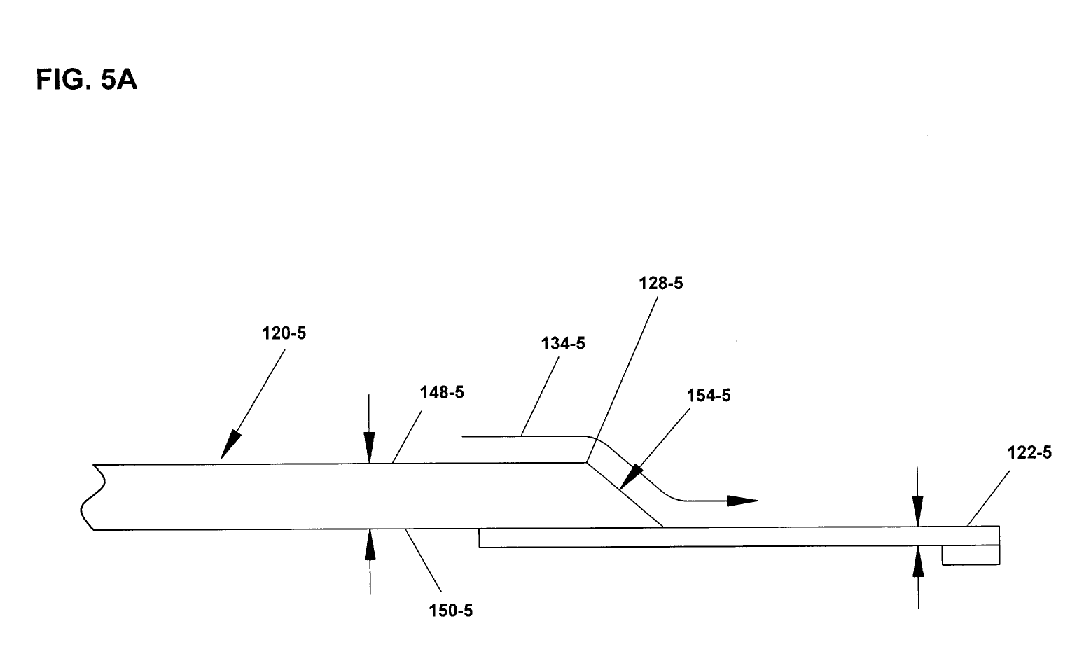

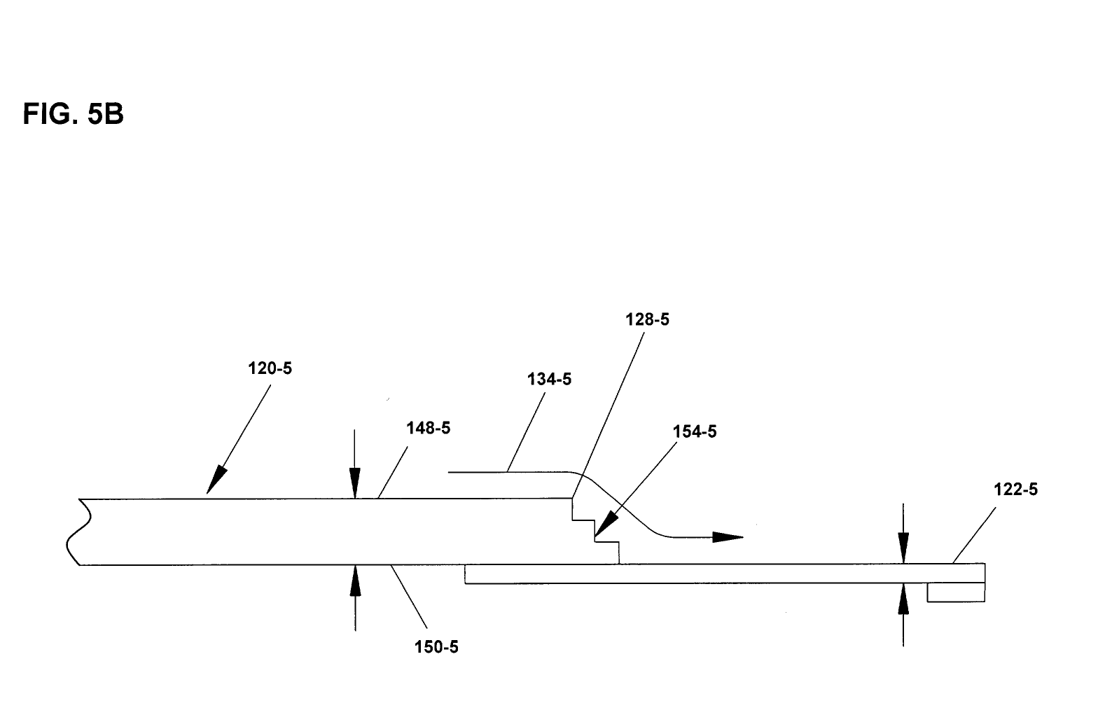

As illustrated in the embodiment of FIG. 5 where like numbers are used to refer to like parts in the previous Figures, the present invention relates to a tapered or profiled transition zone 154-5 between the actuator arm 120-5 and the suspension assembly 122-5 or suspension arm as schematically shown. The tapered or profiled transition zone 154-5 is provided to reduce flow turbulence and streamline flow at the transition zone between the actuator arm 120-5 and the suspension assembly 122-5. In the illustrated embodiment, the tapered or profiled transition zone 154-5 includes a tapered cantilevered edge 128-5 or tapered thickness dimension or profile at the cantilevered edge between opposed surfaces 148-5, 150-5 of the actuator arm 120-5. The tapered thickness profile 128-5 at the cantilevered edge provides a gradual flow transition between the actuator arm 120-5 and suspension assembly 122-5. Although a particular tapered profile is shown in FIG. 5A, application is not limited to the particular linear taper shown. For example, FIG. 5B illustrates one embodiment which includes a tapered step profile. The taper profile could also be curvilinear, as illustrated, for example, by each taper 160, 162 in FIG. 6.

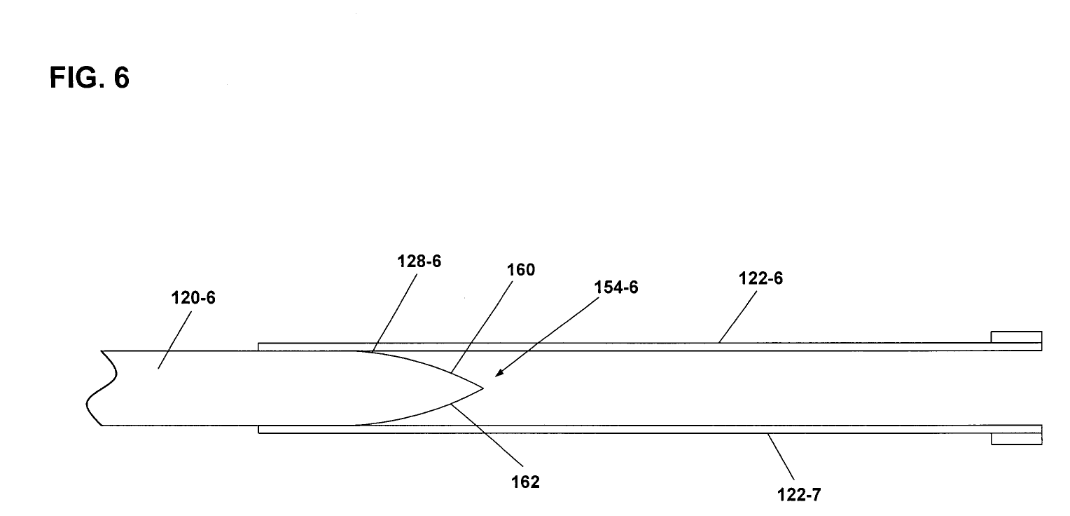

FIGS. 6-7 illustrate an embodiment of tapered or profiled transition zone 154-6 for an actuator arm 120-6 supporting opposed first and second suspension assemblies 122-6, 122-7. In the embodiment shown in FIGS. 6-7, the actuator arm 120-6 includes a tapered cantilevered edge 128-6 or tapered thickness dimension or profile at the cantilevered edge. As shown, the tapered thickness profile includes converging inclined or tapering surfaces 160,162 to provide a flow transition between the actuator arm 120-6 and the opposed first and second suspension assemblies 122-6,122-7 as shown. Although a particular converging tapering surface or profile is illustrated in FIGS. 6-7, application of the present invention is not limited to the particular embodiment illustrated in FIGS. 6-7, nor limited to converging inclined or tapered surfaces as shown. In particular, the inclined or tapered surfaces 160,162 can have a linear, chamfered or beveled 5 profile 160-8, 162-8 as generally shown in FIG. 8 or a curvilinear profile 160-9, 1629 as shown in FIG. 9.

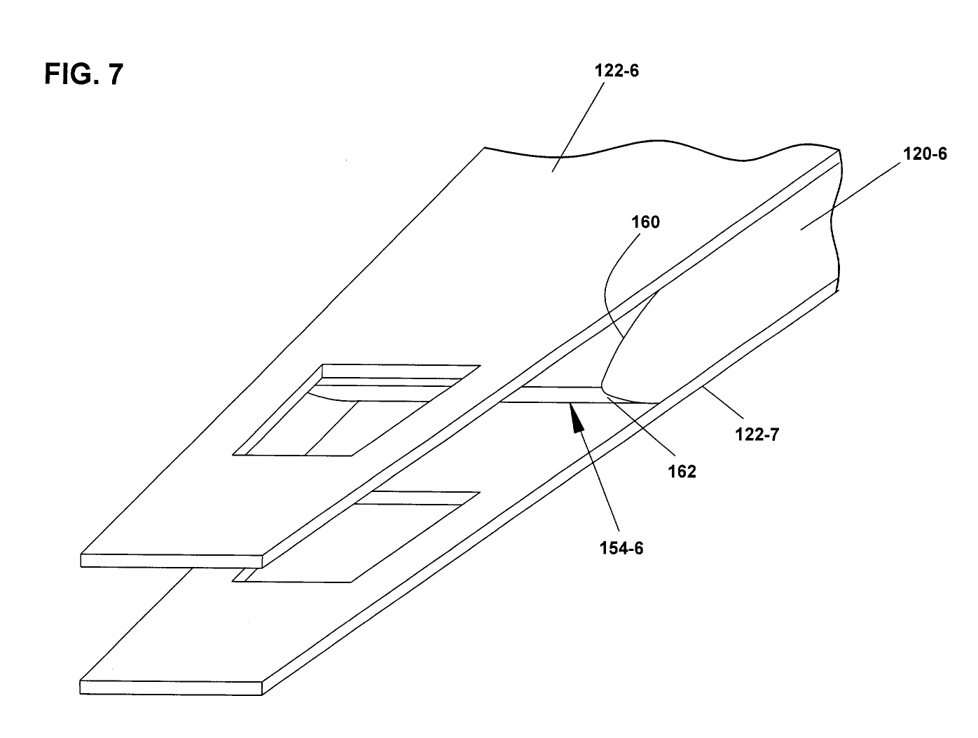

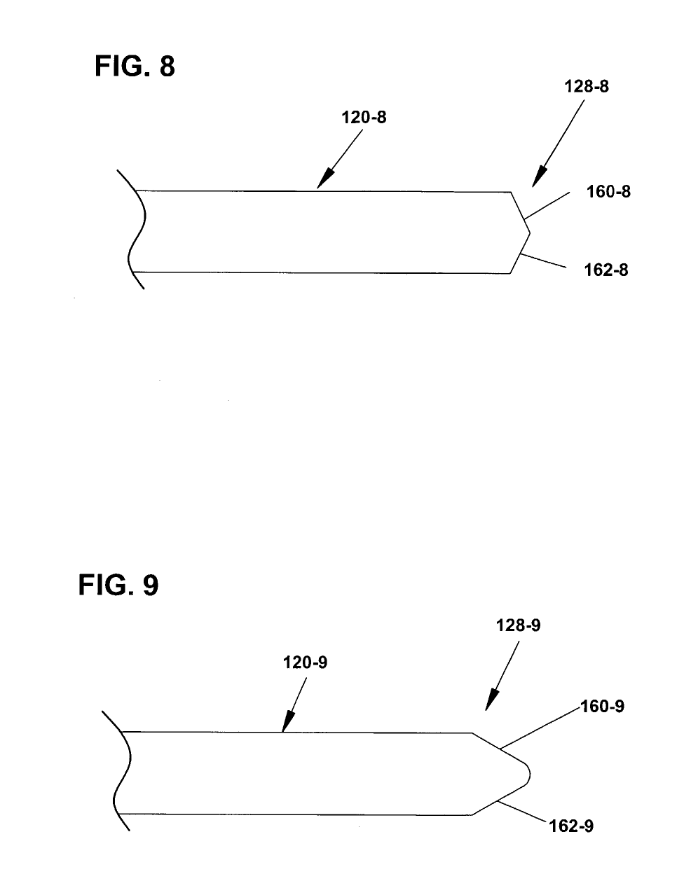

FIGS. 10-12 illustrate an embodiment of an actuator arm 120-10 of an actuator assembly including mounting portion 130-10 to couple suspension assemblies to the cantilevered end of the actuator arm. In the illustrated embodiment, the mounting portion 130-10 includes a swaging hole 164 to swage suspension assemblies to the actuator arm although application of the present invention is not limited to a particular mounting portion including a swaging hole. Shear layers generated along edges of the mounting portion can increase excitation of a base plate (not shown) of the suspension assembly coupled to the mounting portion and the pre-load bend region 140. In the illustrated embodiment, mounting portion 130-10 includes a tapered or profiled transition zone 154-10 including a tapered or profiled cantilevered edge 128-10 having a tapered or profiled thickness dimension as shown in FIGS. 10-11 to reduce flow induced excitations.

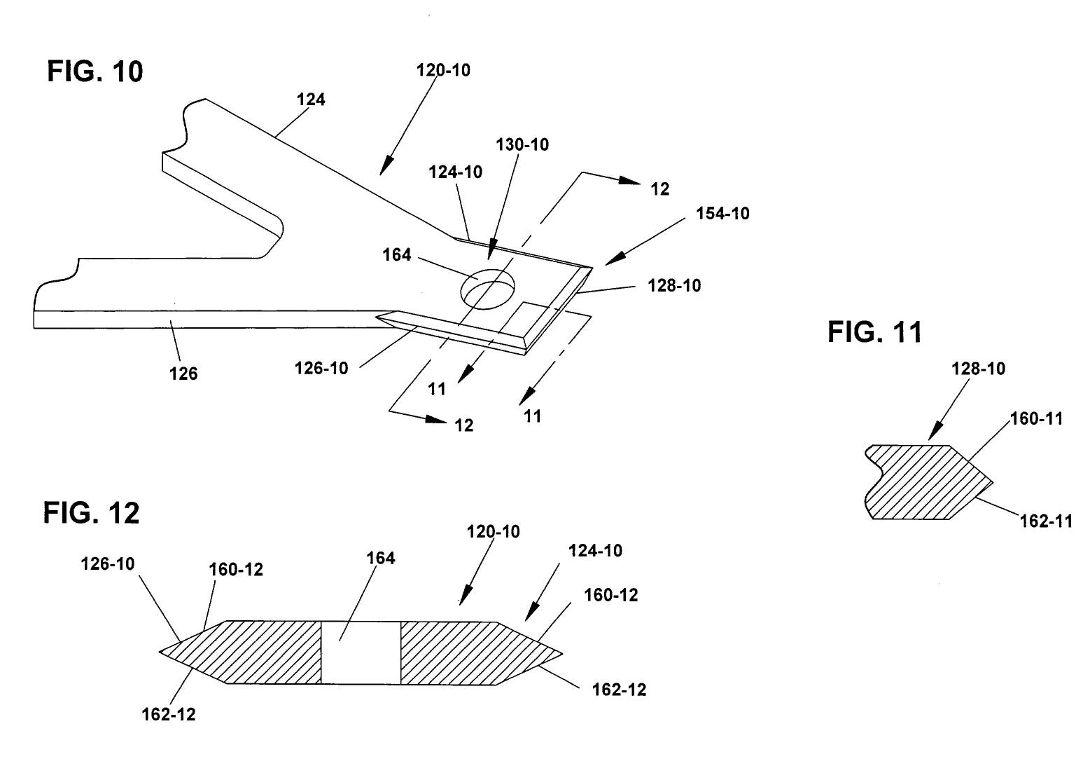

As shown in FIGS. 10 and 12 side edges 124-10,126-10 along the mounting portion 130-10 include a tapered thickness profile or dimension to provide a tapered flow transition along the mounting portion or transition zone between the actuator arm and suspension assemblies. As illustrated in FIG. 11, the tapered or profiled cantilevered edge 128-10 includes converging tapering surfaces 160-11, 162-11 although application is not limited to the particular profile or embodiment shown. As illustrated in FIGS. 10 and 12, the tapered or profiled side edges 12410, 126-10 include converging surfaces 160-12, 162-12, although application of the present invention is not limited to converging surfaces as shown.

Thus, as shown, the tapered or profiled edges provide a tapered transition zone to streamline flow to reduce flow induced excitation. Although in the illustrated embodiment of FIGS. 10 and 12 the first and second side edges 124-10, 126-10 of the mounting portion 130-10 are tapered or profiled, application of the present invention is not limited to tapering or profiling both the first and second side edge 124-10, 126-10 as shown, and one of the side edges 124-10 or 126-10 along the mounting portion 130-10 of the actuator arm can be tapered or profiled to provide a desired flow transition between the actuator arm and the suspension assembly. The actuator arm can be fabricated with the tapered thickness using machining, casting or other fabrication techniques. Alternatively a tapered edge can be adhered to or attached to a fabricated arm to provide the tapered thickness profile.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although preferred embodiment described herein are directed to a particular data storage device, it will be appreciated by those skilled in the art that the teachings of the present invention can be applied to other data storage devices, without departing from the scope and spirit of the present invention.

What is claimed is:

1. An actuator assembly comprising:
at least one longitudinally extending arm comprising:
opposed first and second surfaces defining a thickness therebetween;
first and second longitudinally extending side edges; and
a distal edge connecting the side edges, the distal edge having a first tapered thickness profile between the first and second surfaces; and
a first longitudinally extending suspension having a first end coupled to the first surface of the at least one arm.

2. The actuator assembly of claim 1 wherein the tapered thickness profile is one of a tapered linear profile, a tapered curvilinear profile, or a tapered stepped profile.

3. The actuator assembly of claim 1, further comprising:
a second longitudinally extending suspension coupled to the second surface of the at least one arm, the tapered thickness profile providing a flow transition interface between the at least one arm and the first and second suspensions.

4. The actuator assembly of claim 3 in which the tapered thickness profile includes converging tapering surfaces between the first and second surfaces of the at least one arm.

5. The actuator assembly of claim 4 in which each of the converging tapering surfaces has one of a tapered linear profile, a tapered curvilinear profile, or a tapered stepped profile.

6. The actuator assembly of claim 1, further comprising:
a mounting portion having an area defined by the first and second side edges and the distal edge of the at least one arm, the first suspension being coupled to the mounting portion, at least one of the opposed first or second side edges along the mounting portion including a second tapered thickness profile.

7. The actuator assembly of claim 6 in which both of the first and second side edges along the mounting portion have a tapered thickness profile.

8. The actuator assembly of claim 6 wherein the mounting portion includes a swaging hole.

9. A data storage device, comprising:
a storage medium; and
the actuator assembly of claim 1, in which the actuator assembly is configured to support a transducer over the storage medium.

10. The data storage device of claim 9 in which the data storage medium comprises a rotating disc.

11. An actuator assembly comprising:
at least one longitudinally extending arm comprising:
first and second longitudinally extending side edges;
first and second opposed surfaces defining a thickness therebetween;
a distal edge connecting the first and second side edges and defining a tapered thickness profile between the first and second surfaces; and
a mounting portion proximate to the distal edge, the mounting portion being defined by portions of the first and second side edges and the distal edge, the mounting portion including a swaging hole.

12. The actuator assembly of claim 11 in which the mounting portion includes a tapered thickness profile along at least one of the opposed first or second side edge portions.

13. The actuator assembly of claim 12 in which the mounting portion includes a tapered thickness profile along both of the opposed first and second side edge portions.

14. The actuator assembly of claim 11 in which the-tapered thickness profile is one of a tapered linear profile, a tapered curvilinear profile, or a tapered stepped profile.

15. The actuator assembly of claim 11, further comprising:
a first suspension coupled to the mounting portion of the at least one arm via the swaging hole, the tapered thickness profile providing a flow transition between the thickness of the at least one arm and the first suspension assembly.

16. The actuator assembly of claim 15, further comprising:
a second suspension coupled to the mounting portion of the at least one arm, the tapered thickness profile including opposed converging tapering surfaces to provide a flow transition between the at least one actuator arm and the first and second suspensions.

17. A data storage device, comprising:
a storage medium; and
the actuator assembly of claim 11, in which the actuator assembly is configured to support a transducer over the storage medium.

18. The data storage device of claim 17 in which the data storage medium comprises a rotating disc.

19. A method for reading data from or writing data to a data storage media comprising steps of:
rotating the data storage media to provide an air flow along the data storage media;
energizing an actuator assembly, including at least one actuator arm having a suspension assembly coupled thereto, to position a head coupled to the suspension assembly for read/write operations; and
contouring the air flow along a transition zone between the at least one actuator arm and the suspension assembly to reduce flow induced excitation.

20. The method of claim 19 in which the step of contouring the air flow employs a tapered flow transition between the at least one actuator arm and the suspension assembly to reduce the flow induced excitation.
